(19) United States
(12) Patent Application Publication
(10) Pub. No.: US 2014/0074601 A1
(43) Pub. Date: Mar. 13, 2014

(54) METHODS AND SYSTEMS FOR MOBILE AD TARGETING

(71) Applicant: Asher Delug, Los Angeles, CA (US)

(72) Inventor: Asher Delug, Los Angeles, CA (US)

(21) Appl. No.: 13/623,844

(22) Filed: Sep. 20, 2012

Related U.S. Application Data
(60) Provisional application No. 61/698,449, filed on Sep. 7, 2012.

(51) Int. Cl. G06Q 30/02

(52) U.S. Cl. 705/14.53; 705/14.64

(57) ABSTRACT

Among other disclosed subject matter, a computer-implemented method for providing audience targeting for advertisements is disclosed. The method includes determining information associated with one or more applications installed on a user's computing device. The method further includes determining one or more names, categories, or manufacturers associated with the one or more installed applications. Additionally, the method includes selecting one or more advertisements based at least in part on the determined one or more name, category, or manufacturer associated with the one or more applications. The method includes transmitting the one or more advertisements to the user's computing device for production in the user's computing device.

### CLAIM OF PRIORITY

This application claims the benefit of U.S. Provisional Application Ser. No. 61/698,449, filed Sep. 7, 2012, which is incorporated herein by reference for all purposes in its entirety.

### FIELD

The present invention generally relates to providing services and information to a mobile device user. More particularly, the present invention relates to methods and systems for determining a dynamic array of services and information, to provide a mobile device user, based on the information available through the mobile device.

### BACKGROUND

Smartphones have become increasingly popular in recent years. Smartphones not only have the capabilities of making calls but also allow applications to be installed and executed. Examples of such smartphones include Apple's iPhone as well as models from Nokia and Motorola, and other similar smartphone devices. Smartphones have been developed with a number of operating systems (OS), including Windows-based smartphones and Android-based smartphones. As the popularity of such phones increases, the number of smartphone applications available has increased as well. Applications available for smartphones include games, utilities like calendars, business applications, and applications that render certain web sites in a particular way on a given smartphone, e.g., the Facebook and NYTimes applications for iPhone. Applications developers, such as mobile game developers, can agree to permit delivery of advertisements to ad slots available between content pages of the mobile application as the pages are being viewed by the mobile phone user. However, the present techniques for matching a mobile phone user with the appropriate advertisements that appeal to the user (i.e. audience targeting) are inadequate and result in poor advertisement revenue realization for the application developers and media publishers when compared to realization through other mediums such as desktops computers.

Current targeting techniques in mobile advertising rely on the following techniques: 1) environment targeting that is based on country, carrier, device, and OS, such as an ad campaign that targets just U.S. Verizon users; 2) active App targeting that is based on the app that the user is currently using, such as an ad campaign for a dating service that will be shown within the content pages of dating apps; and 3) using third party data services to target based on user profile information purchased from such services, such as an ad campaign for a feminine product that will be only shown to women, where a user's sex is determined based on the user profile information purchased from third party data services.

Among teaching a variety of other things, certain aspects of the inventions herein have embodiments which may satisfy one or more of the above-described issues.

### SUMMARY OF THE DESCRIPTION

The present invention relates to methods and systems for determining a dynamic array of services and information, to provide a mobile device user, based on the information available through the mobile device. In a first aspect, a computer-implemented method for providing audience targeting for advertisements is disclosed. The method includes determining information associated with one or more applications installed on a user's computing device. The method includes determining one or more of a name, category, or a manufacturer associated with the one or more applications. The method includes selecting one or more advertisements based at least in part on the determined one or more name, category, or manufacturer associated with the one or more applications. The method includes transmitting the one or more advertisements to the user's computing device for production in the user's computing device.

Implementations can include any, all, or none of the following features. The method can further include, where the determined one or more applications includes applications that are currently running in the user's computing device, including applications running in a background mode. The method further includes, where the determined one or more applications includes an application that is currently the active application running in the user's computing device. The method further includes, where the determined one or more applications includes an application that is installed in a given location of the user's computing device. Here, the given location includes one or more of a desktop location of the user's computing device, the entire user's computing device, a favorites folder location in the user's computing device, or a location maintaining a list of frequently executed applications. The method further includes, where the selecting the one or more advertisements includes determining an advertisement related to an application or a product having similarity to the name, category, or the manufacturer of the determined one or more applications.

In addition, the method includes, where the selecting the one or more advertisements includes determining an advertisement related to an application that is not included in the determined one or more applications. The method further includes, where the selecting the one or more advertisements includes determining an advertisement related to an application developed by a given manufacturer that is competitive to the manufacturer of the determined one or more applications. The method further includes, where selecting the one or more advertisements further includes determining environment details associated with the user's computing device. Here, the environmental details includes at least one of a geographic location associated with a current usage of the user's computing device, a device model associated with the user's computing device, a network carrier associated with the user's computing device, or a usage pattern associated with the user's computing device.

The method further includes determining a usage pattern associated with the user's selection of one or more applications over a period of time. The method further includes determining a user profile model based at least in part on the determined usage pattern associated with the one or more applications. The method further includes further selecting the one or more advertisements based at least in part on the determined user profile model associated with the user. The method further includes determining a list of select users associated with a particular activity, where the select users were selected from a pool of users determined to have used at least one application related to the particular activity. Here, the list of select users is selected as a given percentage of the pool of users.

The method further includes selecting the one or more advertisements to the user's computing device based at least in part on the user being part of the list of select users. The method further includes, where the transmitting of the one or more advertisements includes transmitting the advertisement when the determined one or more applications is currently the active application on the user's computing device. The method further includes, where the transmitting of the one or more advertisements includes transmitting the advertisement when the currently active application on the user's computing device is a competitor associated with the manufacturer of the determined one or more applications.

In a second aspect, a computer-implemented method for providing audience targeting for advertisements is disclosed. The method includes determining information associated with an application that is currently active in a user's mobile computing device. The method includes determining one or more of a name, category, or a manufacturer associated with the determined application. The method includes selecting one or more advertisements based at least in part on the determined one or more name, category, or manufacturer associated with the determined application. The method includes transmitting one or more advertisements to the user's computing device for production in the user's computing device, where the production of the one or more advertisements is performed in conjunction with the active application.

In a third aspect, a computer-implemented method for providing audience targeting for advertisements is disclosed. The method includes determining information associated with one or more applications installed in a user's mobile computing device. The method includes determining one or more of a name, category, or a manufacturer associated with the determined one or more applications. The method includes selecting a first subset of applications from the determined one or more applications, where the first subset of applications is associated with a given category of applications. The method includes determining whether a number of the first subset of applications is over a given threshold. The method includes transmitting one or more advertisements, based on the number being over the threshold, to the user's computing device, where the one or more advertisements is based at least in part on the given category.

Implementations can include any, all, or none of the following features. The method can further include, where the transmitting of the one or more advertisements includes transmitting the advertisement when the currently active application on the user's computing device is a competitor associated with the manufacturer of the determined one or more applications.

In a fourth aspect, a computer-implemented method for providing audience targeting for advertisements is disclosed. The method includes determining information associated one or more applications installed in a user's mobile computing device. The method includes determining one or more of a name, category, or a manufacturer associated with the determined one or more applications. The method includes selecting a first subset of applications from the determined one or more applications, where the first subset of applications is associated with applications that have been determined to be active in the user's computing device for at least a threshold period over a given period of time. The method includes determining a usage pattern of the first subset of applications. The method includes determining a profile for the user based at least in part on the determined usage pattern of the user. The method includes transmitting one or more advertisements to the user's computing device, the one or more advertisements based at least in part on the determined profile.

Implementations can include any, all, or none of the following features. Other advantages and features will become apparent from the following description and claims. It should be understood that the description and specific examples are intended for purposes of illustration only and are not intended to limit the scope of the present disclosure.

### BRIEF DESCRIPTION OF DRAWINGS

These and other objects, features, and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIG. 2 illustrates a mobile phone and the list of installed apps on the mobile phone;

FIG. 3 illustrates Audience Profile Targeting in a mobile phone;

FIG. 4 illustrates App-Specific Targeting and Exclusion in a mobile phone;

FIG. 5 is a flow chart illustrating audience profile targeting and app-specific targeting and exclusion to select and suggest advertisements and new applications to a mobile phone user; and

FIG. 6 is a high-level block diagram showing an example of the architecture for a computer system.

The headings provided herein are for convenience only and do not necessarily affect the scope or meaning of the claimed invention.

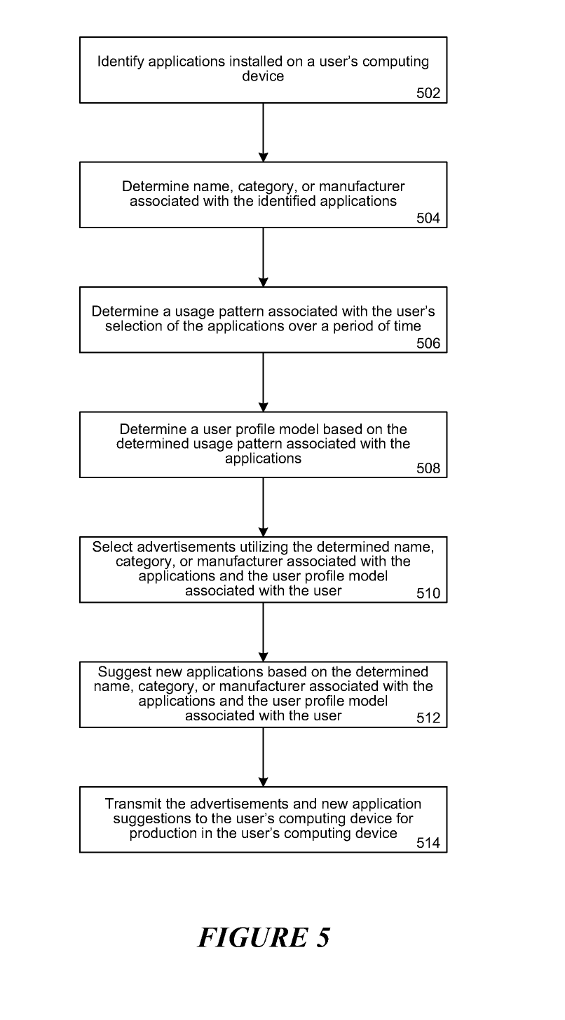

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 504 is first introduced and discussed with respect to FIG. 5).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

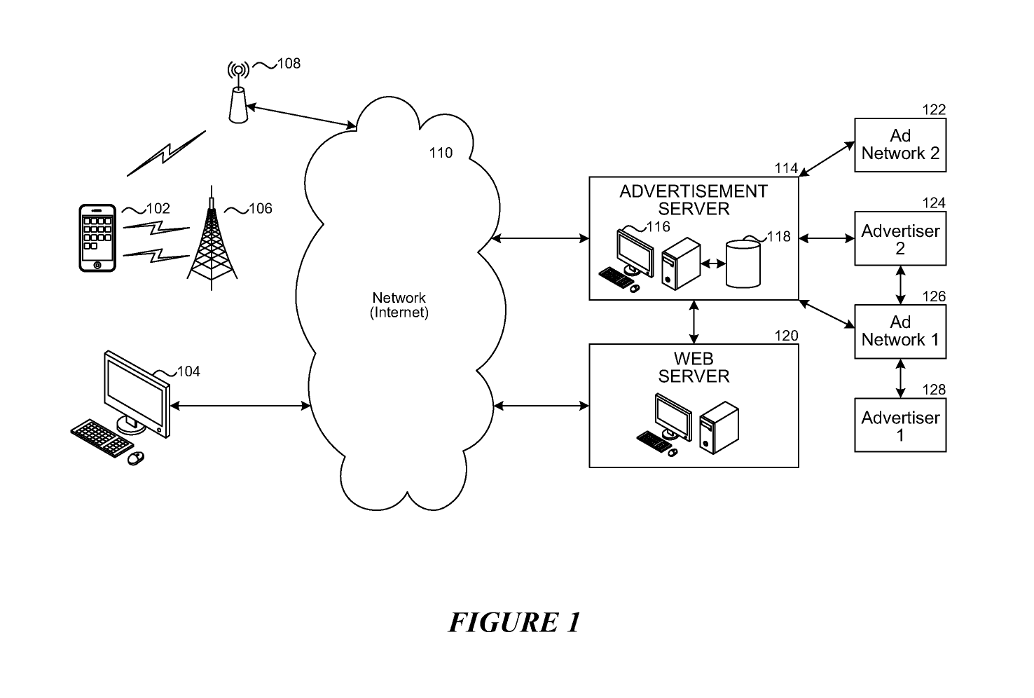

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the invention may be distributed over the Internet or over other networks (including wireless networks) on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a mobile device 102, a personal computer 104, etc.) to communicate with a network. The term “mobile device,” as used herein, may be a cell phone, a personal digital assistant (PDA), a portable email device (e.g., a Blackberry®), a portable media player (e.g., an iPod Touch®), or any other device having communication capability to connect to the network. In one example, the mobile device 102 connects using one or more cellular transceivers or base station antennas 106 (in cellular implementations), access points, terminal adapters, routers, or modems 108 (in IP-based telecommunications implementations), or combinations of the foregoing (in converged network embodiments).

In some instances, the network 110 is the Internet, allowing the mobile device 102 (with, for example, WiFi capability) or the personal computer 104 to access web content offered through various web servers. In some instances, especially where the mobile device 102 is used to access web content through the network 110 (e.g., when a 3G or an LTE service of the mobile device 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the mobile device 102, the personal computer 104, etc.) to connect to the advertisement server 114 through the network 110. In one embodiment, a mobile device 102 may allow access to the advertisement server 114 through the network 110 by using a mobile application (“app”) resident on the mobile device 102 and executable by selection of an application icon associated with the mobile application. In another embodiment, a mobile device 102 may allow the advertisement server 114 to send content over the network 110 for the mobile device 102. The received content could be accessed by selection of a host icon associated with the received content, where the selection allows access to any received content through the mobile device 102. The received content may include content associated with the mobile application requesting the received content (e.g., a mapping service app requesting related road traffic information), display advertisements provided by the advertisers to publish within the mobile application, suggestions for new apps that the user might be interested in, etc.

In one embodiment, the advertisement server 114 utilizes the information available through the user's mobile device when choosing content to provide the mobile application running on the user's mobile device. For example, content such as display advertisements provided by the advertisers to publish within the mobile application, suggestions for new apps that the user might be interested in, etc. are based on information available through the user's mobile device. In one embodiment, the information available through the user's mobile device could include the names, developer information, categories, etc. that are associated with apps that are installed on the mobile device or tagged as favorites by the user of the mobile device in, say, the app store. In one instance, the advertisement server 114 could gather the information available through the user's mobile device by utilizing the appropriate APIs to request the mobile device to provide the information requested through the APIs. In another instance, the mobile device may be authorized by the user of the mobile device to periodically send the relevant information to the advertisement server. It should be noted that these suggested methods for gathering the information available through the mobile device are for illustrative purposes only and are not meant to limit the number of means for gathering the information available through the mobile devices. Any method that is well-known in the art for gathering the information available through the mobile devices could be utilized for the intended purpose.

In embodiments, the advertisement server 114 may utilize the information available through the user's mobile device, specifically information such as the names, developer information, categories, etc. that are associated with apps that are installed on the mobile device, to perform selection of new apps to suggest to the user. The new apps may be suggested to the user through banner advertisements, rich-media type advertisements, app walls (an advertisement unit with a list of apps that a user can pick and choose from to install on their mobile device), etc. In one instance, the advertisement server 114 may suggest one or more new apps to the mobile device user based on the commonality of the information associated with the mobile apps installed on the mobile device and the one or more new apps suggested to the user. In one instance, when suggesting one or more new apps to the user, the advertisement server 114 may consider the commonality of the category between the mobile apps installed on the mobile device and the one or more new apps suggested to the user.

For example, the advertisement server 114 may target mobile users with apps installed from dating services, such as eHarmony or Match.com, with apps from Zoosk, another dating service provider. The new Zoosk apps may be suggested to the user through banner advertisements in any of the applications that are currently being used by the user, such as a banking application, without regard to the names, developer information, categories, etc. that are associated with the applications that are currently being used by mobile device user. The suggestion (i.e., targeting) of the new apps by the advertisement server 114 is thus independent of the nature of the active app currently being used by the mobile user. In another example, the advertisement server 114 can suggest users with games from Mobage, a provider of social games, installed on their mobile device with apps from Zynga, another provider of social games. Again, the new Zynga apps may be suggested to the user through banner advertisements in any of the applications that are currently being used by the user, such as a banking application, without regard to the names, developer information, categories, etc. that are associated with the active applications that are currently being used by mobile device user.

In another instance, the advertisement server 114 may not only consider the commonality of the category between the mobile apps installed on the mobile device and the one or more new apps suggested to the user but also the usage pattern of the various mobile apps installed on the mobile device. The usage pattern may include the last date the app was used by the user, frequency of use of the app by the user, weighted number of uses of the app by the user within a given period of time, etc. In one instance, when performing the commonality analysis for suggesting new apps to the mobile user, the advertisement server 114 may filter the list of apps installed on the mobile phone based on their usage pattern and may only utilize the filtered list of apps that show significant recent usage by the user in the commonality analysis.

For example, the advertisement server 114 may utilize the launch of an app within the last 30-day period as a threshold to filter installed apps on the user's mobile device that can be considered by advertisement server 114 when performing the commonality analysis. In this example, the eHarmony app was launched 5 times within the last 30-day period while Match.com app was launched 8 times within the last 30-day period. The advertisement server 114 may then target the mobile user using the eHarmony and Match.com dating services apps with apps from Zoosk, another dating service provider. The new Zoosk apps may be suggested to the user through banner advertisements in any of the applications that are currently being used by the user, such as a banking application, without regard to the names, developer information, categories, etc. that are associated with the applications that are currently being used by mobile device user. The suggestion (i.e. targeting) of the new apps by the advertisement server 114 is thus independent of the nature of the active app currently being used by the mobile user.

In another instance, the advertisement server 114 may utilize the information available through the user's mobile device, specifically information such as the names, developer information, categories, etc. that are associated with apps that are installed on the mobile device, to perform exclusion on the new apps to suggest to the user. The new apps may be suggested to the user through banner advertisements, rich-media type advertisements, app walls (an advertisement unit with a list of apps that a user can pick and choose from to install on their mobile device), etc. Here, the advertisement server 114 may exclude one or more apps from being suggested as new apps to the user utilizing the information available through the user's mobile device. In one instance, the advertisement server 114 may perform the exclusion of the one or more apps based on the commonality of the information associated with the mobile apps installed on the mobile device and the one or more apps excluded from the list of suggested new apps. In one instance, when excluding one or more apps from being suggested as a new app to the user, the advertisement server 114 may consider the commonality of the app names between the mobile apps installed on the mobile device and the one or more apps excluded from the new app suggestion list. In another instance, when excluding one or more apps from being suggested as a new app to the user, the advertisement server 114 may consider the mismatch between the category of mobile apps installed on the mobile device and the category of the one or more apps to be excluded from the new app suggestion list. In one instance, the advertisement server 114 may utilize a preconfigured list of mismatched categories to determine such exclusion of new apps from being suggested to the mobile user.

For example, the advertisement server 114 may exclude mobile users with the game Fruit Ninja already installed on their mobile device from being prompted again with the game Fruit Ninja as a suggestion for a new app. In another example, the advertisement server 114 may exclude mobile users with the apps from dating services, such as Zoosk, when the mobile user has apps relating to wedding planners and wedding countdowns, apps that might signify either an upcoming wedding or a recent wedding. The mobile users, who are about to get married or already married, will benefit little from apps relating to dating services.

In certain embodiments, the advertisement server 114 may utilize the information available through the user's mobile device, specifically information such as the names, developer information, categories, etc. that are associated with apps that are installed on the mobile device, to create and associate user profiles for the mobile user. The user profiles may capture characteristics of the mobile user that advertisers can utilize when targeting their advertisements. The captured characteristics could include a mobile user's shopping preferences, any health-related interests, sporting interests, hobbies, the category of online games most interested in, etc.

In one instance, a given mobile user may be associated with more than one profile at the same time. The advertisers could access these profiles through the advertisement server 114 when targeting their advertisements. The advertisers may suggest the advertisement server 114 to target their ads at mobile users with one or more or a combination of user profiles. For example, the advertisement server 114 may include predefined characteristics profiles, such as “Hardcore Garners,” “Shopaholics,” “Baby Needs,” etc., that are based at least in part on the characteristics of installed apps on the user's mobile device. For instance, the “Hardcore Garners” group should only include users with at least five installed gaming apps (where, in one instance, the identification of an app's category, such as games, shopping, etc. might be based on the meta-data associated with the app in the App Store). The “Shopaholics” group of should include only users with at least three shopping apps, while the “Baby Needs” group should only include users with at least one installed baby app.

In one instance, the advertisement server 114 may determine and associate one or more user profiles with each mobile user the server 114 serves advertisements and other information to. The advertisement server 114 may receive user targeting information from the advertisers as part of an ad campaign, where the advertisement server 114 could be provided with a set of advertisements and the attributes of the users the advertisements should be displayed to. The advertisement server 114 may match the commonality between the attributes of the various user profiles and the attributes provided by the advertisers in determining the user profiles preferred by the advertiser in targeting their advertisements. The advertisement server 114 may then serve the advertisements from the advertiser to the mobile users who have the user profiles preferred by the advertiser. For example, Zynga, a social games provider, may target users with the “Hardcore Garners” profile associated with them. Similarly, Ebay, an auction service provider, can target the users with the “Shopaholics” user profile associated with them. Also, J 'n J, baby products vendor, can target the users of the “Baby Needs” group. The targeted users may be provided with suggestions for new apps or advertisements that best match their interest (as suggested by their user profile). The new apps and advertisements may be provided to the user through banner advertisements, rich-media type advertisements, app walls (an advertisement unit with a list of apps that a user can pick and choose from to install on their mobile device), etc.

For purpose of further illustration, it is useful to consider the techniques explained herein as it applies to content offered in a mobile device. Of course, however, it should be noted that the techniques introduced here extend to other types of situations where the content is offered for other computational platforms, such as desktop computers, tablets, etc.

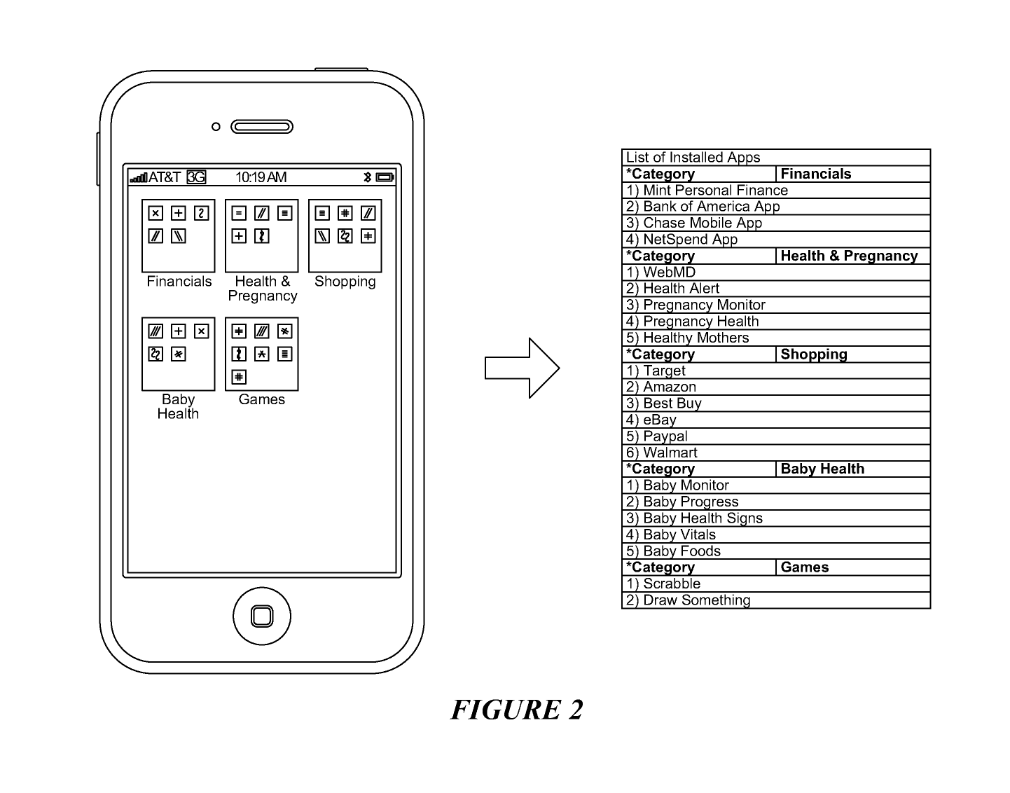

An illustration of the above example of using information available on a user's mobile device, specifically information associated with the apps installed on the user's mobile device, which is used to customize the advertisements and information provided to the mobile user is discussed in relation to FIGS. 2 through 6.

FIG. 2 illustrates a mobile device with various applications and their associated application icons that are grouped under various categories respectively. The advertisement server 114 may request the mobile device to send a list of applications that are installed on the mobile device through the network 110. FIG. 2 illustrates a list of installed applications that might be received by the advertisement server 114. In another instance, the advertisement server 114 may determine the applications installed on the mobile device by querying the mobile device for information that might help determine the installed applications. The advertisement server 114 may query the mobile device to provide information of applications listed in a given location of the user's mobile device, where the given location could include a home screen (i.e., desktop location) of the user's mobile device, the user's apps store account, a favorites folder location in the user's mobile device, or a location maintaining a list of frequently executed applications. The advertisement server 114 may also query the mobile device to provide usage information associated with the various identified apps, such as frequency of use of an app, date of last launch of an app, data bandwidth usage of an app, etc.

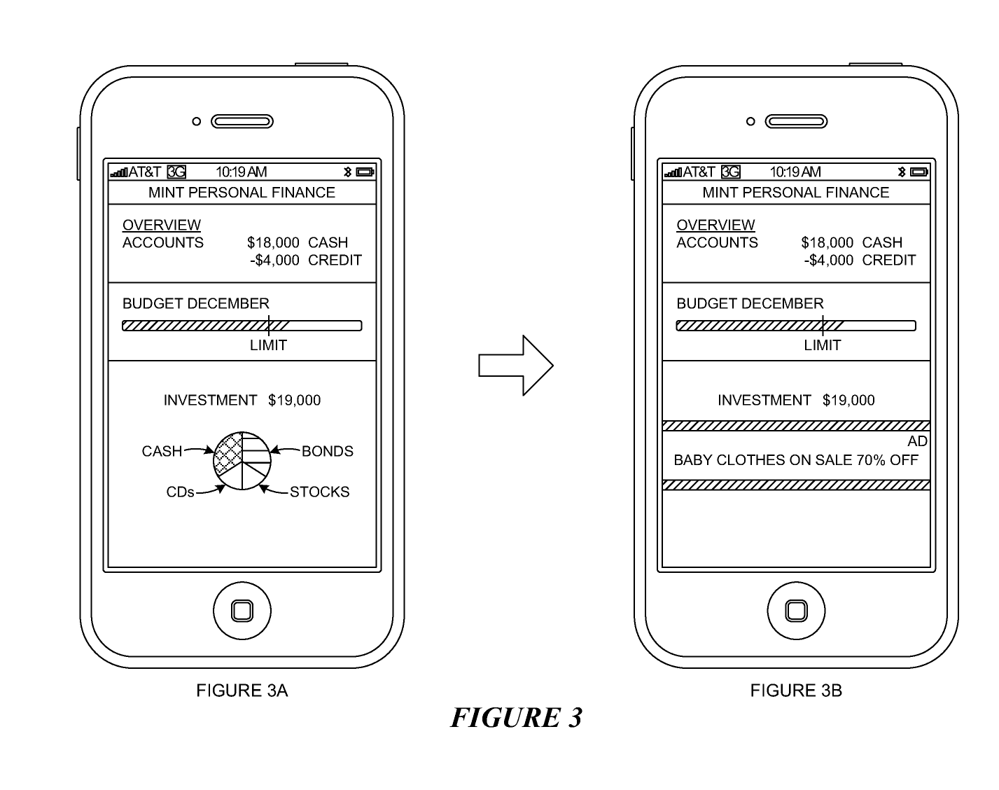

FIG. 3, sub FIGS. 3A and 3B illustrate targeting based on audience profile. Here, in FIGS. 3A and 3B, the advertisement server 114 has determined and associated a user profile of “Baby Needs” to the mobile user based on the “Baby Health” apps determined in FIG. 2 for the same mobile user. The mobile user has five “Baby Needs” related apps and therefore qualifies under the attributes associated with the “Baby Needs” profile. In FIG. 3A, the mobile user is shown accessing the user's personal finances through a financial services related app called Mint. The Mint app is the currently active app being used by the mobile user. In FIG. 3B, the advertisement server 114 serves the mobile user with advertisements related to baby clothes as a banner ad at the bottom of the mobile device screen. Here, the advertisement server 114 relied at least in part on the user profile “Baby Needs” associated with the mobile user when determining to serve the mobile user with advertisements for baby clothes. The advertisement server 114 did not rely only on the contextual information of the currently active app to provide the advertisement, where in this case, a financial app would have generally prompted a financial products related advertisement when relying only on the contextual information of the currently active app.

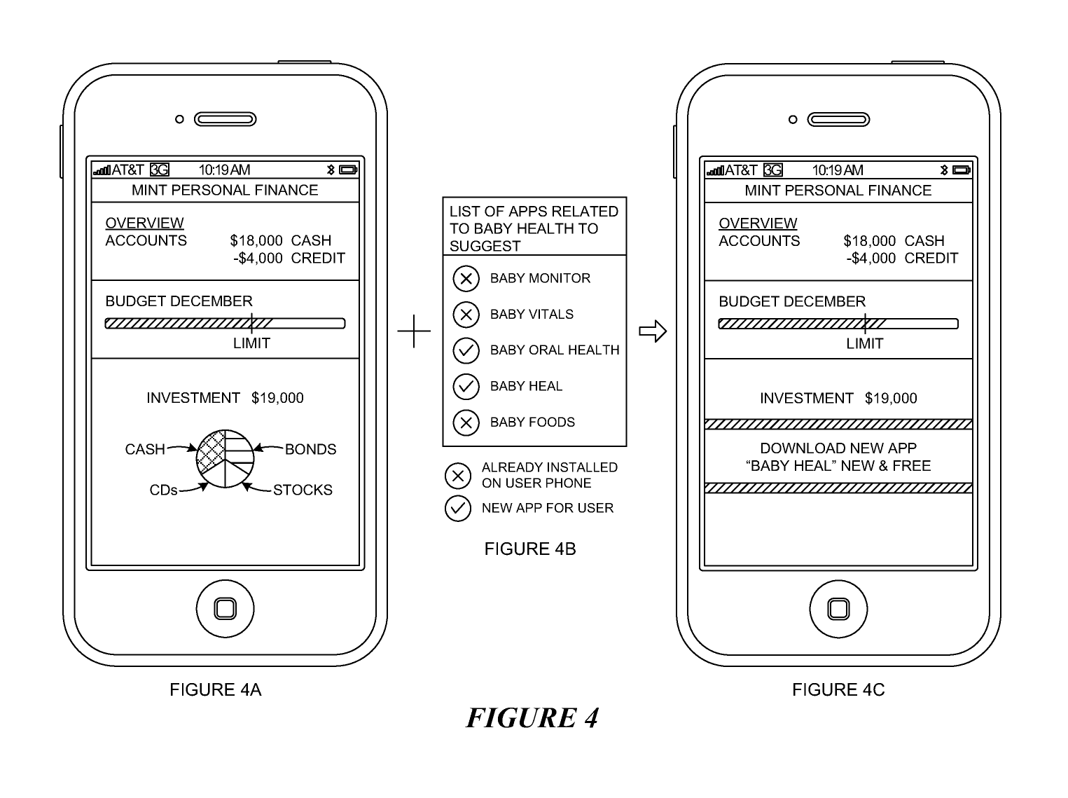

FIG. 4, sub FIGS. 4A, 4B, and 4C illustrate customizing the advertisements and information provided to the mobile user based on information available through the mobile device, specifically information associated with the apps installed on the user's mobile device. Here, FIGS. 4A and 4C illustrate a mobile device running a financial application, Mint, with a banner advertisement for a new app “Baby Heal.” In determining the suggestion for the new app “Baby Heal,” the advertisement server 114 utilizes the list of apps installed on the mobile device identified in FIG. 2.

In one instance, the advertisement server 114 may be requested by the developer of the “Baby Heal” app to advertise the new app to all mobile users with other baby apps such as “Baby Monitor,” “Baby Foods,” or “Baby Vitals.” When the advertisement server 114 identifies a mobile user with any of the three apps installed on their mobile phone, the server 114 includes “Baby Heal” to a list of suggested apps (FIG. 4B) for the mobile user. The next time the advertisement server 114 serves an advertisement to the mobile user, the advertisement server 114 may choose an app from the list of suggested apps that was previously compiled by the server 114. For example, when the mobile user's financial application Mint has an ad slot for a banner ad, the advertisement server 114 may choose “Baby Heal” as the new app to suggest to the user in the display banner ad. In one instance, if the list of suggested apps was compiled before a certain threshold of time (say, 1 week before), the advertisement server 114 might recompile the list of available applications on the user's phone and re-determine whether the new app should be suggested to the user.

In another instance, the advertisement server 114 may be requested by the developer of the “Baby Monitor” app to advertise the new app to all mobile users with other baby apps such as “Baby Heal,” “Baby Foods,” or “Baby Vitals.” When the advertisement server 114 identifies a mobile user with any of the three apps installed on their mobile phone, the server 114 may next check whether the app “Baby Monitor” is already installed on the user's mobile device before including “Baby Monitor” to a list of suggested apps (FIG. 4B) for the mobile user. For example, in FIG. 2, the list of installed apps shows that the mobile phone includes apps “Baby Foods” and Baby Vitals.” So, the advertisement server 114 would next check whether app “Baby Monitor” is already installed on the mobile phone using the list of installed apps.

When the advertisement server 114 identifies the app as already being installed, the server 114 excludes the app “Baby Monitor” from being included in the suggested list of apps. When the advertisement server 114 does not identify the app “Baby Monitor” as already being installed on the mobile device, the server 114 includes the app in the list of suggested apps for the user. The next time the advertisement server 114 serves an advertisement to the mobile user, the advertisement server 114 may choose an app from the list of suggested apps that was previously compiled by the server 114. For example, when the mobile user's financial application, Mint, has an ad slot for a banner ad, the advertisement server 114 may choose “Baby Monitor” as the new app to suggest to the user in the display banner ad. In one instance, if the list of suggested apps was compiled before a certain threshold of time (say, 1 week before), the advertisement server 114 might recompile the list of available applications on the user's phone and re-determine whether the new app should be suggested to the user.

FIG. 5 is a flow chart illustrating both audience profile targeting (discussed in conjunction with FIG. 3) and app-specific targeting and exclusion (discussed in conjunction with FIG. 4) to select and suggest advertisements and new applications to a mobile phone user. In step 502, the advertisement server 114 identifies applications installed on a user's computing device (such as a mobile device). In one instance, the advertisement server 114 queries the mobile device to provide the list of applications executed within a two-month period and receives, from the mobile device, the applications installed on the mobile device. In step 504, the advertisement server 114 determines a name, category, or manufacturer associated with each of the applications identified in step 504. In one instance, the advertisement server 114 could query the mobile device for meta-data associated with each application and parse the received meta-data to identify the pertinent information associated with each application.

In step 506, the advertisement server 114 determines a usage pattern for each of the identified applications. In one instance, the usage pattern could be based on usage information of the application. The advertisement server 114 queries the mobile device again to request for usage information associated with each of the identified applications. The usage information could include frequency of use of each application, the last date of use/launch of an application, the data bandwidth consumption of each application, etc. In one instance, the advertisement server could bucket the various applications based on their usage patterns, such as light use, regular use, heavy use, etc., where the degree of use is based on a function of the various usage information parameters such as frequency of use of each application, the last date of use/launch of an application, the data bandwidth consumption of each application, etc

In step 508, the advertisement server 114 determines a user profile model for the mobile user based on the determined usage pattern associated with the applications. For example, if the user has at least five games in the combined regular and heavy use categories, then a user profile of “Hardcore Garners” can be associated with the mobile user. Similarly, if the user has at least one app related to babies in their heavy use category, then an additional user profile of “Baby Needs” can be associated with the mobile user.

In step 510, the advertisement server 114 picks advertisements for the mobile user utilizing the information such as determined name, category, or manufacturer associated with the identified applications (determined in step 504) and the various user profiles (determined in step 508) associated with the user. For example, if the user profile of the mobile user includes “Baby Needs,” then advertisements from J n' J (a baby products vendor) can be displayed to the mobile user. In another example, if the mobile user includes apps related to babies, such as “Baby Vitals,” then the mobile user is served with advertisements from J n' J (a baby products vendor) in any active app irrespective of whether the contextual information of the active app (i.e., the active app is related to financial products) necessarily supports the relevance of J n' J advertisement to the mobile user.

In step 512, the advertisement server 114 picks new apps for the mobile user utilizing the information such as determined name, category, or manufacturer associated with the identified applications (determined in step 504) and the various user profiles (determined in step 508) associated with the user. For example, if the user profile of the mobile user includes “Baby Needs” and a maker of new baby app “Baby Heal” wishes to target mobile users with the “Baby Needs” profile, then advertisements with the new app “Baby Heal” will be displayed to the mobile user. In another example, if the mobile user has apps related to babies, such as “Baby Vitals” and the maker of new baby app “Baby Heal” wishes to target mobile users with the “Baby Vitals” app, then advertisements with the new app “Baby Heal” will be displayed to the mobile user in any active app irrespective of whether the contextual information of the active app (i.e., the active app is related to financial products) necessarily supports the relevance of the “Baby Heal” advertisement to the mobile user. In another example, if the mobile user has apps related to babies, such as “Baby Vitals” and the maker of the new baby app “Baby Heal” wishes to target mobile users with the “Baby Vitals” app, then the advertisement server 114 determines if the app “Baby Heal” is already one of the installed apps on the user's mobile device. If not, then the advertisements with the new app “Baby Heal” will be displayed to the mobile user in any active app irrespective of whether the contextual information of the active app (i.e., the active app is related to financial products) necessarily supports the relevance of the “Baby Heal” advertisement to the mobile user. If the app “Baby Heal” is already one of the installed apps on the user's mobile device, then the mobile user will not shown advertisements with the app “Baby Heal” as a new suggested app. In step 514, the advertisement server 114 transmits the advertisements and new application suggestions to the user's mobile device for production in the user's mobile device. The production can be within a banner ad within an app, in an app wall, as a rich-media ad that expands, etc.

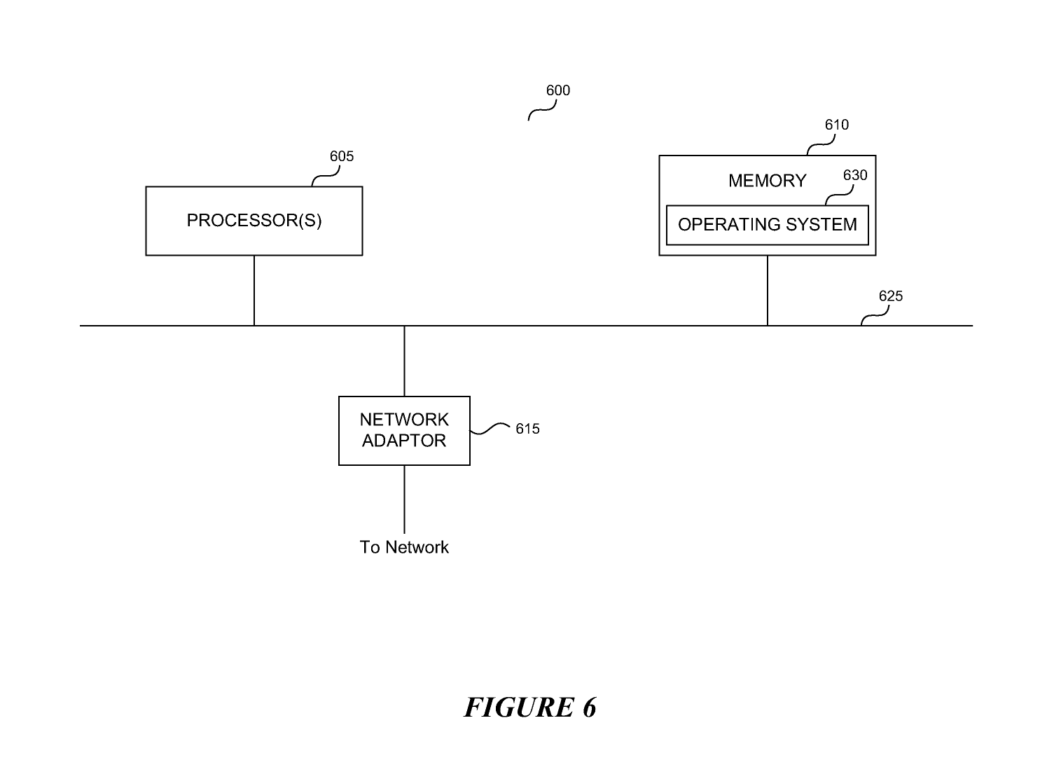

FIG. 6 is a high-level block diagram showing an example of the architecture for a computer system 600 that can be utilized to implement an advertisement server (e.g., 114 from FIG. 1), a web server (e.g., 125 from FIG. 1), etc. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire.”

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application-specific integrated circuits (ASICs), programmable logic devices (PLDs), or the like, or a combination of such devices.

The memory 610 is or includes the main memory of the computer system 600. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further, any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 7 will begin with the words “means for.”) Accordingly, the applicant reserves the right to add additional claims after filing the application to pursue such additional claim forms for other aspects of the invention.

1. A method, comprising:
determining, by an advertising server having a memory component for storing computer-executable instructions and a processor for accessing the memory component and for performing the method, information associated with one or more applications installed on a user's computing device;
determining, by the advertising server, one or more of a name, category, or a manufacturer associated with the one or more applications;
selecting, by the advertising server, one or more advertisements based at least in part on the determined one or more name, category, or manufacturer associated with the one or more applications;
transmitting, by the advertising server, the one or more advertisements to the user's computing device for production in the user's computing device.

2. The method of claim 1, wherein the determined one or more applications includes applications that are currently running in the user's computing device, including applications running in a background mode.

3. The method of claim 1, wherein the determined one or more applications includes an application that is currently the active application running in the user's computing device.

4. The method of claim 1, wherein the determined one or more applications includes an application that is installed in a given location of the user's computing device, the given location including one or more of a desktop location of the user's computing device, the entire user's computing device, a favorites folder location in the user's computing device, or a location maintaining a list of frequently executed applications.

5. The method of claim 1, wherein the selecting the one or more advertisements includes determining an advertisement related to an application or a product having similarity to the name, category, or the manufacturer of the determined one or more applications.

6. The method of claim 1, wherein the selecting the one or more advertisements includes determining an advertisement related to an application that is not included in the determined one or more applications.

7. The method of claim 1, wherein the selecting the one or more advertisements includes determining an advertisement related to an application developed by a given manufacturer that is competitive to the manufacturer of the determined one or more applications.

8. The method of claim 1, wherein the selecting the one or more advertisements further includes:
determining, by the advertising server, environment details associated with the user's computing device, the environmental details including at least one of a geographic location associated with a current usage of the user's computing device, a device model associated with the user's computing device, a network carrier associated with the user's computing device, or a usage pattern associated with the user's computing device.

9. The method of claim 1, further comprising:
determining, by the advertising server, a usage pattern associated with the user's selection of the one or more applications over a period of time;
determining, by the advertising server, a user profile model based at least in part on the determined usage pattern associated with the one or more applications; and
further selecting the one or more advertisements based at least in part on the determined user profile model associated with the user.

10. The method of claim 1, further comprising:
determining, by the advertising server, a list of select users associated with a particular activity, the select users selected from a pool of users determined to have used at least one application related to the particular activity, wherein the list of select users is selected as a given percentage of the pool of users;
selecting the one or more advertisements to the user's computing device based at least in part on the user being part of the list of select users.

11. The method of claim 1, wherein the transmitting of the one or more advertisements includes transmitting the advertisement when the determined one or more applications is currently the active application on the user's computing device.

12. The method of claim 1, wherein the transmitting of the one or more advertisements includes transmitting the advertisement when the currently active application on the user's computing device is a competitor associated with the manufacturer of the determined one or more applications.

13. A method, comprising:
determining, by an advertising server having a memory component for storing computer-executable instructions and a processor for accessing the memory component and for performing the method, information associated with an application that is currently active in a user's mobile computing device;
determining, by the advertising server, one or more of a name, category, or a manufacturer associated with the determined application;
selecting, by the advertising server, one or more advertisements based at least in part on the determined one or more name, category, or manufacturer associated with the determined application; and
transmitting, by the advertising server, the one or more advertisements to the user's computing device for production in the user's computing device, the production of the one or more advertisements being in conjunction with the active application.

14. A method, comprising:
determining, by an advertising server having a memory component for storing computer-executable instructions and a processor for accessing the memory component and for performing the method, information associated with one or more applications installed in a user's mobile computing device;
determining, by the advertising server, one or more of a name, category, or a manufacturer associated with the determined one or more applications;
selecting, by the advertising server, a first subset of applications from the determined one or more applications, the first subset of applications being associated with a given category of applications;
determining whether a number of the first subset of applications is over a given threshold;
based on the number being over the threshold, transmitting one or more advertisements to the user's computing device, the one or more advertisements based at least in part on the given category.

15. The method of claim 1, wherein the transmitting of the one or more advertisements includes transmitting the advertisement when the currently active application on the user's computing device is a competitor associated with the manufacturer of the determined one or more applications.

16. A method, comprising:
determining, by an advertising server having a memory component for storing computer-executable instructions and a processor for accessing the memory component and for performing the method, information associated with one or more applications installed in a user's mobile computing device;
determining, by the advertising server, one or more of a name, category, or a manufacturer associated with the determined one or more applications;
selecting, by the advertising server, a first subset of applications from the determined one or more applications, the first subset of applications being associated applications that have been determined to be active in the user's computing device for at least a threshold period over a given period of time;
determining, by the advertising server, a usage pattern of the first subset of applications;
determining, by the advertising server, a profile for the user based at least in part on the determined usage pattern of the user;
transmitting one or more advertisements to the user's computing device, the one or more advertisements based at least in part on the determined profile.

17. A system, comprising:
at least one memory storing computer-executable instructions; and
at least one processor configured to access the at least one memory and execute the computer-executable instructions to perform a set of acts, the acts including:
determining information associated with one or more applications installed on a user's computing device;
determining one or more of a name, category, or a manufacturer associated with the one or more applications;
selecting one or more advertisements based at least in part on the determined one or more name, category, or manufacturer associated with the one or more applications;
transmitting the one or more advertisements to the user's computing device for production in the user's computing device.

18. The system of claim 17, wherein the determined one or more applications includes applications that are currently running in the user's computing device, including applications running in a background mode.

19. The system of claim 17, wherein the determined one or more applications includes an application that is currently the active application running in the user's computing device.

20. The system of claim 17, wherein the determined one or more applications includes an application that is installed in a given location of the user's computing device, the given location including one or more of a desktop location of the user's computing device, the entire user's computing device, a favorites folder location in the user's computing device, or a location maintaining a list of frequently executed applications.

21. The system of claim 17, wherein the selecting of the one or more advertisements includes determining an advertisement related to an application or a product having similarity to the name, category, or the manufacturer of the determined one or more applications.

22. The system of claim 17, wherein the selecting the one or more advertisements includes determining an advertisement related to an application that is not included in the determined one or more applications.

23. The system of claim 17, wherein the selecting the one or more advertisements includes determining an advertisement related to an application developed by a given manufacturer that is competitive to the manufacturer of the determined one or more applications.

24. The system of claim 17, wherein the selecting the one or more advertisements further includes:
determining, by the advertising server, environment details associated with the user's computing device, the environmental details including at least one of a geographic location associated with a current usage of the user's computing device, a device model associated with the user's computing device, a network carrier associated with the user's computing device, or a usage pattern associated with the user's computing device.

25. The system of claim 17, further comprising:
determining, by the advertising server, a usage pattern associated with the user's selection of the one or more applications over a period of time;
determining, by the advertising server, a user profile model based at least in part on the determined usage pattern associated with the one or more applications; and
further selecting the one or more advertisements based at least in part on the determined user profile model associated with the user.

26. The system of claim 17, further comprising:
determining, by the advertising server, a list of select users associated with a particular activity, the select users selected from a pool of users determined to have used at least one application related to the particular activity, wherein the list of select users is selected as a given percentage of the pool of users;
selecting the one or more advertisements to the user's computing device based at least in part on the user being part of the list of select users.

27. The system of claim 17, wherein the transmitting of the one or more advertisements includes transmitting the advertisement when the determined one or more applications is currently the active application on the user's computing device.

28. The system of claim 17, wherein the transmitting of the one or more advertisements includes transmitting the advertisement when the currently active application on the user's computing device is a competitor associated with the manufacturer of the determined one or more applications.

29. One or more computer-readable media storing computer-executable instructions that, when executed by at least one processor, configure the at least one processor to perform operations corresponding to a method for monitoring domains, the method comprising:
determining information associated with an application that is currently active in a user's mobile computing device;
determining one or more of a name, category, or a manufacturer associated with the determined application;
selecting one or more advertisements based at least in part on the determined one or more name, category, or manufacturer associated with the determined application; and
transmitting the one or more advertisements to the user's computing device for production in the user's computing device, the production of the one or more advertisements being in conjunction with the active application.

30. One or more computer-readable media storing computer-executable instructions that, when executed by at least one processor, configure the at least one processor to perform operations corresponding to a method for monitoring domains, the method comprising:
determining information associated one or more applications installed in a user's mobile computing device;
determining one or more of a name, category, or a manufacturer associated with the determined one or more applications;
selecting a first subset of applications from the determined one or more applications, the first subset of applications being associated with a given category of applications;
determining whether a number of the first subset of applications is over a given threshold; and
based on the number being over the threshold, transmitting one or more advertisements to the user's computing device, the one or more advertisements based at least in part on the given category.

31. The computer-readable media of claim 30, wherein the transmitting of the one or more advertisements includes transmitting the advertisement when the currently active application on the user's computing device is a competitor associated with the manufacturer of the determined one or more applications.
